(19) United States
(12) Patent Application Publication
(10) Pub. No.: US 2026/0245302 A1
(43) Pub. Date: Aug. 20, 2026

(54) Reconstruction Priors for Scene Coordinate Regression

(71) Applicant: Niantic Spatial, Inc., San Francisco, CA (US)

(72) Inventors: Wenjing Bian, Oxford (GB); Axel Barroso-Laguna, Barcelona (ES); Tommaso Cavallari, Oxford (GB); Victor Adrian Prisacariu, Oxford (GB); Eric Brachmann, Dresden (DE)

(21) Appl. No.: 19/543,443

(22) Filed: Feb. 18, 2026

Related U.S. Application Data
(60) Provisional application No. 63/760,062, filed on Feb. 18, 2025.

(51) Int. Cl. G06T 17/00; A63F 13/52; A63F 13/60; G06N 3/0475; G06N 3/09; G06T 7/70

(52) U.S. Cl. CPC G06T 17/00; A63F 13/52; A63F 13/60; G06N 3/0475; G06N 3/09; G06T 7/70; G06T 2207/30244

(57) ABSTRACT

A scene representation model uses a 3D diffusion prior to push predicted 3D scene points towards plausible geometries during training. The plausible geometries are learned by training a second model (e.g., a diffusion model) on a set of scene agnostic training data from a variety of scenes. In other words, the second model encodes information about what geometries are plausible in the real world, enabling inferences to be made about the geometry for novel scenes where incomplete data is available.

### CROSS-REFERENCE TO RELATED APPLICATIONS

This application claims the benefit of co-pending U.S. Provisional Patent Application No. 63/760,062, filed on Feb. 18, 2025, which is incorporated by reference.

### BACKGROUND

### 1. Technical Field

The subject matter described relates generally to camera relocalization, and, in particular, to using a scene agnostic model to generate a prior for training a scene coordinate regression model.

### 2. Problem

Camera relocalization generally refers to a process for determining the location and orientation (collectively the “pose”) of a camera within an environment using images captured by the camera. Camera relocalization has a wide and increasing array of uses. In augmented reality (AR) applications, a virtual environment is co-located with a real-world environment. If the pose of a camera capturing images of the real-world environment (e.g., a video feed) is accurately determined, virtual elements can be overlaid on the depiction of the real-world environment (a “scene”) with precision, thereby enhancing the user experience. For example, a virtual hat may be placed on top of a real statue, a virtual character may be depicted partially behind a physical object, or the like.

Scene coordinate regression (SCR) models have proven to be powerful implicit scene representations for 3D vision, enabling visual relocalization and structure-from-motion. SCR models are trained specifically for one scene. However, if the training images provide insufficient multi-view constraints to recover the scene geometry, SCR models degenerate. This is impractical because developers cannot easily train, test, and refine SCR models for every scene in which they might be used. There is thus a need for improved scene representation models and training techniques that can consistently provide accurate representations of a scene.

### SUMMARY

The present disclosure describes approaches to training a scene coordinate regression (SCR) model. The approaches use a scene agnostic model (e.g., a 3D diffusion model) to generate a prior that is used to push predicted 3D scene points generated by the SCR model towards plausible geometries during training. The scene agnostic model is trained on scene agnostic training data from a variety of environments. In other words, the scene agnostic model encodes information about what geometries are plausible in the real world, enabling inferences to be made about the geometry for novel scenes where incomplete data is available. In various embodiments, training the scene representation model using hints/direction provided by the scene agnostic model provides improved scene representations with more coherent scene point clouds and increased camera relocalization accuracy relative to conventionally-trained SCR models. In one embodiment, the SCR model is an Accelerated Coordinate Encoding (ACE) model that is modified to receive hints/direction during training (for a specific scene) from a point cloud diffusion model trained on scene agnostic training data.

### BRIEF DESCRIPTION OF THE DRAWINGS

FIG. 1 illustrates a networked computing environment, according to one embodiment.

FIG. 2 depicts a representation of a virtual world having a geography that parallels the real world, according to one embodiment.

FIG. 3 depicts an exemplary game interface of a parallel reality game, according to one embodiment.

FIG. 4 is a conceptual diagram that depicts the general training process of a SCR model, according to one embodiment.

FIG. 5A is a conceptual diagram that depicts the incorporation of a scene agnostic model into the training of the SCR model to provide measures of likelihood of point clouds generated by the SCR model, according to one embodiment.

FIG. 5B is a conceptual diagram that depicts the use of the SCR model to predict poses after training of the SCR model using the scene agnostic model, according to one embodiment.

FIG. 6 is a flowchart of a method for training the SCR model, according to one embodiment.

FIG. 7 is a flowchart of a method for training the SCR model that incorporates priors generated using a scene agnostic model, according to one embodiment.

FIG. 8 is a flowchart of a method for generating camera poses using the SCR model, according to one embodiment.

FIG. 9 illustrates an example computer system suitable for use in training or applying a SCR model, according to one embodiment.

The figures and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures.

### DETAILED DESCRIPTION

Various embodiments are described in the context of a parallel reality game that includes augmented reality content in a virtual world geography that parallels at least a portion of the real-world geography such that player movement and actions in the real-world affect actions in the virtual world and vice versa. Those of ordinary skill in the art, using the disclosures provided herein, will understand that the subject matter described is applicable in other situations where determining depth information from image data is desirable, such as non-gaming Alternative Reality (“AR”) applications, self-driving vehicles, and the like. In addition, the inherent flexibility of computer-based systems allows for a great variety of possible configurations, combinations, and divisions of tasks and functionality between and among the components of the system. For instance, the systems and methods according to aspects of the present disclosure can be implemented using a single computing device or across multiple computing devices (e.g., connected in a computer network).

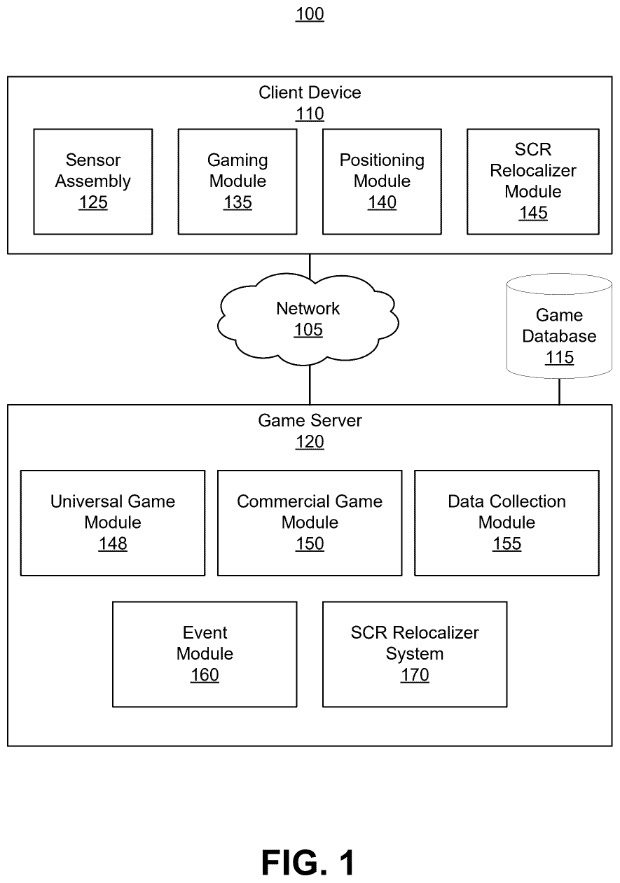

FIG. 1 illustrates a networked computing environment 100, in accordance with one or more embodiments. The networked computing environment 100 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 110 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 110.

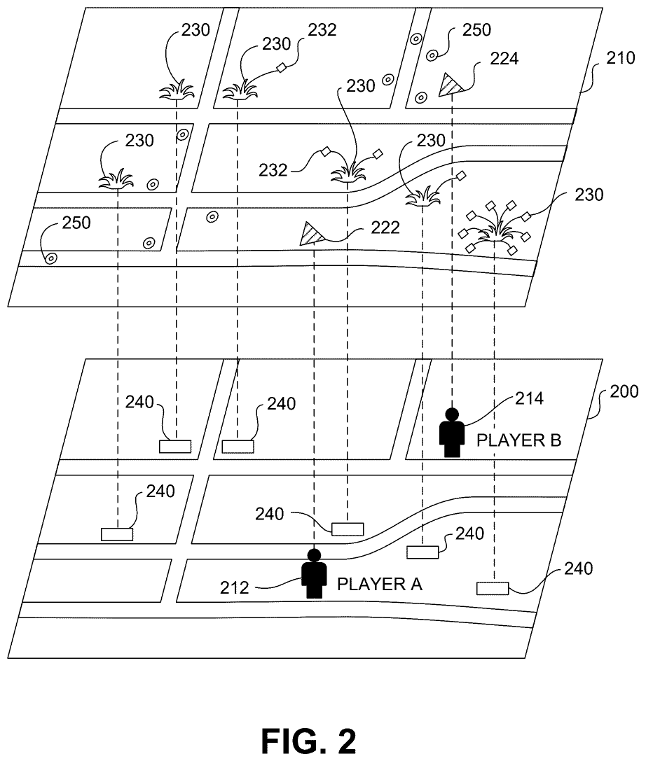

Reference is now made to FIG. 2 which depicts a conceptual diagram of a virtual world 210 that parallels the real world 200 that can act as the game board for players of a parallel reality game, according to one embodiment. As illustrated, the virtual world 210 can include a geography that parallels the geography of the real world 200. In particular, a range of coordinates defining a geographic area or space in the real world 200 is mapped to a corresponding range of coordinates defining a virtual space in the virtual world 210. The range of coordinates in the real world 200 can be associated with a town, neighborhood, city, campus, locale, a country, continent, the entire globe, or other geographic area. Each geographic coordinate in the range of geographic coordinates is mapped to a corresponding coordinate in a virtual space in the virtual world.

A player's position in the virtual world 210 corresponds to the player's position in the real world 200. For instance, the player A located at position 212 in the real world 200 has a corresponding position 222 in the virtual world 210. Similarly, the player B located at position 214 in the real world has a corresponding position 224 in the virtual world. As the players move about in a range of geographic coordinates in the real world, the players also move about in the range of coordinates defining the virtual space in the virtual world 210. In particular, a positioning system (e.g., a GPS system) associated with a mobile computing device carried by the player can be used to track a player's position as the player navigates the range of geographic coordinates in the real world. Data associated with the player's position in the real world 200 is used to update the player's position in the corresponding range of coordinates defining the virtual space in the virtual world 210. In this manner, players can navigate along a continuous track in the range of coordinates defining the virtual space in the virtual world 210 by simply traveling among the corresponding range of geographic coordinates in the real world 200 without having to check in or periodically update location information at specific discrete locations in the real world 200.

The location-based game can include a plurality of game objectives requiring players to travel to or interact with various virtual elements or virtual objects scattered at various virtual locations in the virtual world. A player can travel to these virtual locations by traveling to the corresponding location of the virtual elements or objects in the real world. For instance, a positioning system can continuously track the position of the player such that as the player continuously navigates the real world, the player also continuously navigates the parallel virtual world. The player can then interact with various virtual elements or objects at the specific location to achieve or perform one or more game objectives.

For example, a game objective has players interacting with virtual elements 230 located at various virtual locations in the virtual world 210. These virtual elements 230 can be linked to landmarks, geographic locations, or objects 240 in the real world 200. The real-world landmarks or objects 240 can be works of art, monuments, buildings, businesses, libraries, museums, or other suitable real-world landmarks or objects. Interactions include capturing, claiming ownership of, using some virtual item, spending some virtual currency, etc. To capture these virtual elements 230, a player must travel to the landmark or geographic location 240 linked to the virtual elements 230 in the real world and must perform any necessary interactions with the virtual elements 230 in the virtual world 210. For example, player A of FIG. 2 may have to travel to a landmark 240 in the real world 200 in order to interact with or capture a virtual element 230 linked with that particular landmark 240. The interaction with the virtual element 230 can require action in the real world, such as taking a photograph or verifying, obtaining, or capturing other information about the landmark or object 240 associated with the virtual element 230.

Game objectives may require that players use one or more virtual items that are collected by the players in the location-based game. For instance, the players may travel the virtual world 210 seeking virtual items (e.g., weapons, creatures, power ups, or other items) that can be useful for completing game objectives. These virtual items can be found or collected by traveling to different locations in the real world 200 or by completing various actions in either the virtual world 210 or the real world 200. In the example shown in FIG. 2, a player uses virtual items 232 to capture one or more virtual elements 230. In particular, a player can deploy virtual items 232 at locations in the virtual world 210 proximate or within the virtual elements 230. Deploying one or more virtual items 232 in this manner can result in the capture of the virtual element 230 for the particular player or for the team/faction of the particular player.

In one particular implementation, a player may have to gather virtual energy as part of the parallel reality game. As depicted in FIG. 2, virtual energy 250 can be scattered at different locations in the virtual world 210. A player can collect the virtual energy 250 by traveling to the corresponding location of the virtual energy 250 in the actual world 200. The virtual energy 250 can be used to power virtual items or to perform various game objectives in the game. A player that loses all virtual energy 250 can be disconnected from the game.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. In some embodiments, players can communicate with one another through one or more communication interfaces provided in the game. Players can also obtain enhanced “powers” or virtual items that can be used to complete game objectives within the game. Those of ordinary skill in the art, using the disclosures provided herein, should understand that various other game features can be included with the parallel reality game without deviating from the scope of the present disclosure.

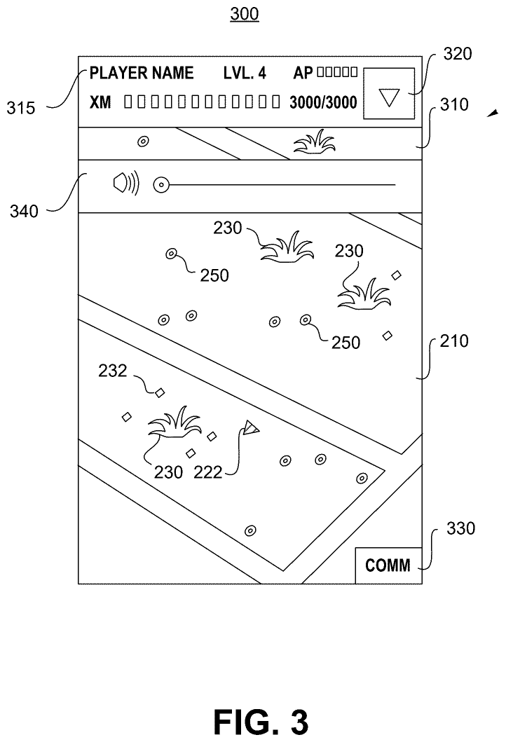

FIG. 3 depicts one embodiment of a game interface 300 that can be presented on a display of a client as part of the interface between a player and the virtual world 210. The game interface 300 includes a display window 310 that can be used to display the virtual world 210 and various other aspects of the game, such as player position 222 and the locations of virtual elements 230, virtual items 232, and virtual energy 250 in the virtual world 210. The user interface 300 can also display other information, such as game data information, game communications, player information, client location verification instructions and other information associated with the game. For example, the user interface can display player information 315, such as player name, experience level and other information. The user interface 300 can include a menu 320 for accessing various game settings and other information associated with the game. The user interface 300 can also include a communications interface 330 that enables communications between the game system and the player and between one or more players of the parallel reality game.

According to aspects of the present disclosure, a player can interact with the parallel reality game by simply carrying a client device 110 around in the real world. For instance, a player can play the game by simply accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 300 can include a plurality of non-visual elements that allow a user to interact with the game. For instance, the game interface can provide audible notifications to the player when the player is approaching a virtual element or object in the game or when an important event happens in the parallel reality game. A player can control these audible notifications with audio control 340. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

Those of ordinary skill in the art, using the disclosures provided, will appreciate that numerous game interface configurations and underlying functionalities will be apparent in light of this disclosure. The present disclosure is not intended to be limited to any one particular configuration.

### Example Systems

The networked computing environment 100 illustrated in FIG. 1 uses a client-server architecture, where a game server 120 communicates with a client device 110 over a network 105 to provide a parallel reality game to players at the client device 110. The networked computing environment 100 also may include other external systems such as sponsor/advertiser systems or business systems. Although only one client device 110 is shown, any number of client devices 110 or other external systems may be connected to the game server 120 over the network 105. Furthermore, the networked computing environment 100 may contain different or additional elements and functionality may be distributed between the client device 110 and the game server 120 in a different manner than described below.

A client device 110 can be any portable computing device that can be used by a player to interface with the game server 120. For instance, a client device 110 can be a wireless device, a personal digital assistant (PDA), portable gaming device, cellular phone, smart phone, tablet, navigation system, handheld GPS system, wearable computing device, a display having one or more processors, or other such device. In another instance, the client device 110 includes a conventional computer system, such as a desktop or a laptop computer. Still yet, the client device 110 may be a vehicle with a computing device. In short, a client device 110 can be any computer device or system that can enable a player to interact with the game server 120. As a computing device, the client device 110 can include one or more processors and one or more computer-readable storage media. The computer-readable storage media can store instructions which cause the processor to perform operations. The client device 110 is preferably a portable computing device that can be easily carried or otherwise transported with a player, such as a smartphone or tablet.

In an embodiment, the client device executes an application allowing the user of the client device 110 to interact with the game server 120 or other components of the system environment 100. For example, a client device 110 can execute an application associated with the parallel reality game to enable interaction between the client device 110 and the game server 120 or other components of the system environment 100 via the network 105. In another embodiment, the client device 110 interacts with the game server 120 or other components of the system environment 100 through an application programming interface (API) running on a native operating system of the client device 110, such as IOS® or ANDROID™.

The client device 110 includes a sensor assembly 125 that captures sensor data describing the physical environment where the client device 110 is. The client device 110 communicates with the game server 120 to provide the sensor data (or data describing the physical environment derived from the sensor data). In the embodiment shown in FIG. 1, each client device 110 includes components such as a gaming module 135, a positioning module 140, and a SCR relocalizer module 145. The client device 110 may include various other input/output devices for receiving information from or providing information to a player. Example input/output devices include a display screen, a touch screen, a touch pad, data entry keys, speakers, and a microphone suitable for voice recognition. The client device 110 may also include additional sensors for recording data from the environment of the client device 110, the sensors including but not limited to, movement sensors, accelerometers, gyroscopes, other inertial measurement units (IMUs), barometers, positioning systems, thermometers, light sensors, microphones, etc.

The client device 110 can further include a network interface (not shown) for providing communications over the network 105. A network interface can include any suitable components for interfacing with one more networks, including for example, transmitters, receivers, ports, controllers, antennas, or other suitable components.

The sensor assembly 125 captures sensor data describing the physical environment. In one embodiment, the sensor assembly 125 includes one or more photo sensors (e.g., cameras) that generate image data. The photo sensors may have varying color capture ranges at varying capture rates. The photo sensors may contain a wide-angle lens or a telephoto lens. The photo sensors 125 may capture single images or video as the image data. The image data can be appended with metadata describing other details of the image data including sensor data from other sensors of the sensor assembly 125 (e.g., temperature, brightness of environment) or capture data (e.g., exposure, warmth, shutter speed, focal length, capture time, etc.). In one instance, the sensor assembly 125 includes one camera and is configured to capture monocular image data. In another instance, the sensor assembly 125 includes two cameras and captures stereoscopic image data. In various other implementations, the camera assembly 125 includes multiple cameras each configured to capture image data.

The gaming module 135 provides a player with an interface to participate in the parallel reality game. The game server 120 transmits game data over the network 105 to the client device 110 for use by the gaming module 135 at the client device 110 to provide local versions of the game to players at locations remote from the game server 120. The game server 120 can include a network interface for providing communications over the network 105. A network interface can include any suitable components for interfacing with one more networks, including for example, transmitters, receivers, ports, controllers, antennas, or other suitable components.

The gaming module 135 executed by the client device 110 provides an interface between a player and the parallel reality game. The gaming module 1 can present a user interface on a display device associated with the client device 110 that displays a virtual world (e.g., renders imagery of the virtual world) associated with the game and allows a user to interact in the virtual world to perform various game objectives. In some other embodiments, the gaming module 135 presents image data from the real world (e.g., captured by the camera assembly 125) augmented with virtual elements from the parallel reality game. In these embodiments, the gaming module 135 may generate virtual content or adjust virtual content according to other information received from other components of the client device 110. For example, the gaming module 135 may adjust a virtual object to be displayed on the user interface according to a depth map of the scene captured in the image data.

The gaming module 135 can also control various other outputs to allow a player to interact with the game without requiring the player to view a display screen. For instance, the gaming module 135 can control various audio, vibratory, or other notifications that allow the player to play the game without looking at the display screen. The gaming module 135 can access game data received from the game server 120 to provide an accurate representation of the game to the user. The gaming module 135 can receive and process player input and provide updates to the game server 120 over the network 105. The gaming module 135 may also generate or adjust game content to be displayed by the client device 110. For example, the gaming module 135 may generate a virtual element based on depth information.

The positioning module 140 can be any device or circuitry for monitoring the position of the client device 110. For example, the positioning module 140 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, based on IP address, by using triangulation or proximity to cellular towers or Wi-Fi hotspots, or other suitable techniques for determining position. The positioning module 140 may further include various other sensors that may aid in accurately positioning the client device 110 location.

As the player moves around with the client device 110 in the real world, the positioning module 140 tracks the position of the player and provides the player position information to the gaming module 135. The gaming module 135 updates the player position in the virtual world associated with the game based on the actual position of the player in the real world. Thus, a player can interact with the virtual world simply by carrying or transporting the client device 110 in the real world. In particular, the location of the player in the virtual world can correspond to the location of the player in the real world. The gaming module 135 can provide player position information to the game server 120 over the network 105. In response, the game server 120 may enact various techniques to verify the client device 110 location to prevent cheaters from spoofing the client device 110 location. It should be understood that location information associated with a player is utilized only if permission is granted after the player has been notified that location information of the player is to be accessed and how the location information is to be utilized in the context of the game (e.g., to update player position in the virtual world). In addition, any location information associated with players will be stored and maintained in a manner to protect player privacy.

The SCR relocalizer module 145 communicates with the game server 120 to obtain the position and orientation (e.g., pose) of the camera in an environment to the gaming module 135 with greater precision than is provided by the positioning module 140 (or in scenarios where the positioning module 140 cannot determine the location of the client device 110). The SCR relocalizer module 145 receives sensor data from one or more sensors of the client device and processes the sensor data. In one embodiment, the SCR relocalizer module 145 receives images of the environment from the camera assembly 125 and, in some instances, other sensor data associated with each image from the other sensors on the client device 110. The SCR relocalizer module 145 sends the sensor data and a request to determine the camera pose to the game server over the network 105 using a communication protocol. The game server 120 determines the camera pose of the client device based on the predicted scene coordinates output by a trained SCR model, and provides the camera pose to the SCR relocalizer module 145 on the client device 110. Alternatively, the SCR relocalizer module 145 may apply a SCR model (e.g., provided by the game server 120) to determine the camera pose locally at the client device 110.

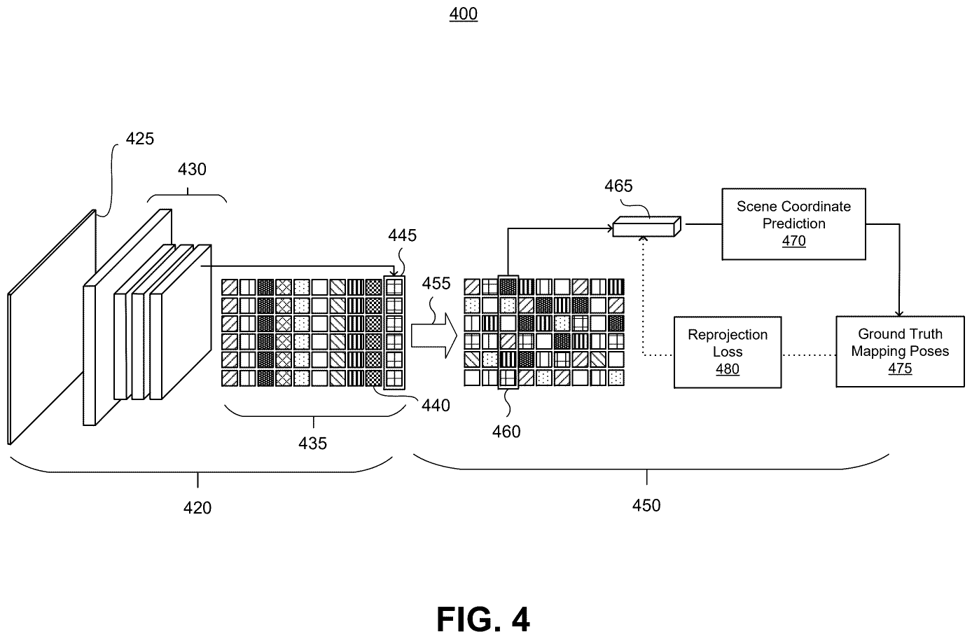

The SCR relocalizer module 145 may provide the camera pose to the gaming module 135, to enable the gaming module 135 to accurately generate virtual content overlaid on images of the real world (e.g., by displaying virtual elements in conjunction with a real-time feed generated from images captured by one or more cameras of the client device 110 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly. Additional details of embodiments of the SCR model and providing training guidance using a scene agnostic model are described in FIGS. 4 through 8.

The game server 120 can include one or more computing devices. The game server 120 can include or can be in communication with a game database 115. The game database 115 stores game data used in the parallel reality game to be served or provided to the client(s) 110 over the network 105. The game data stored in the game database 115 can include: (1) data associated with the virtual world in the parallel reality game (e.g. imagery data used to render the virtual world on a display device, geographic coordinates of locations in the virtual world, etc.); (2) data associated with players of the parallel reality game (e.g. player profiles including but not limited to player information, player experience level, player currency, current player positions in the virtual world/real world, player energy level, player preferences, team information, faction information, etc.); (3) data associated with game objectives (e.g. data associated with current game objectives, status of game objectives, past game objectives, future game objectives, desired game objectives, etc.); (4) data associated with virtual elements in the virtual world (e.g. positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) game status (e.g. current number of players, current status of game objectives, player leaderboard, etc.); (7) data associated with player actions/input (e.g. current player positions, past player positions, player moves, player input, player queries, player communications, etc.); or (8) any other data used, related to, or obtained during implementation of the parallel reality game. The game data stored in the game database 115 can be populated either offline or in real time by system administrators or by data received from users/players of the system, such as from a client device 110 over the network 105.

The game server 120 can be configured to receive requests for game data from a client device 110 (for instance via remote procedure calls (RPCs)) and to respond to those requests via the network 105. For instance, the game server 120 can encode game data in one or more data files and provide the data files to the client device 110. In addition, the game server 120 can be configured to receive game data (e.g. player positions, player actions, player input, etc.) from a client device 110 via the network 105. For instance, the client device 110 can be configured to periodically send player input and other updates to the game server 120, which the game server 120 uses to update game data in the game database 115 to reflect any and all changed conditions for the game.

In the embodiment shown, the game server 120 includes a universal game module 148, a commercial game module 150, a data collection module 155, an event module 160, and an SCR relocalizer system 170. As mentioned above, the game server 120 interacts with a game database 115 that may be part of the game server 120 or accessed remotely (e.g., the game database 115 may be a distributed database accessed via the network 105). In other embodiments, the game server 120 contains different or additional elements. In addition, the functions may be distributed among the elements in a different manner than described. For instance, the game database 115 can be integrated into the game server 120.

The universal game module 148 hosts the parallel reality game for all players and acts as the authoritative source for the current status of the parallel reality game for all players. As the host, the universal game module 148 generates game content for presentation to players, e.g., via their respective client devices 110. The universal game module 148 may access the game database 115 to retrieve or store game data when hosting the parallel reality game. The universal game module 148 also receives game data from client device 110 (e.g. depth information, player input, player position, player actions, landmark information, etc.) and incorporates the game data received into the overall parallel reality game for all players of the parallel reality game. The universal game module 148 can also manage the delivery of game data to the client device 110 over the network 105. The universal game module 148 may also govern security aspects of client device 110 including but not limited to securing connections between the client device 110 and the game server 120, establishing connections between various client device 110, and verifying the location of the various client device 110.

The commercial game module 150, in embodiments where one is included, can be separate from or a part of the universal game module 148. The commercial game module 150 can manage the inclusion of various game features within the parallel reality game that are linked with a commercial activity in the real world. For instance, the commercial game module 150 can receive requests from external systems such as sponsors/advertisers, businesses, or other entities over the network 105 (via a network interface) to include game features linked with commercial activity in the parallel reality game. The commercial game module 150 can then arrange for the inclusion of these game features in the parallel reality game.

The game server 120 can further include a data collection module 155. The data collection module 155, in embodiments where one is included, can be separate from or a part of the universal game module 148. The data collection module 155 can manage the inclusion of various game features within the parallel reality game that are linked with a data collection activity in the real world. For instance, the data collection module 155 can modify game data stored in the game database 115 to include game features linked with data collection activity in the parallel reality game. The data collection module 155 can also analyze and data collected by players pursuant to the data collection activity and provide the data for access by various platforms.

The event module 160 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The SCR relocalizer system 170 trains (or retrieves trained) models for mapping pixels in a query image to corresponding 3D scene points. Mapping pixels to 3D coordinates may mean mapping individual pixels to 3D coordinates or mapping patches of pixels surrounding a primary pixel (e.g., with the primary pixel in the center) to 3D coordinates. The SCR relocalizer system 170 may train SCR models, using a process that is described in FIGS. 4 through 7.

In one embodiment, the SCR relocalizer system 170 applies the trained SCR model to a query image provided by a client device 110 to generate predicted 3D scene coordinates for pixels of the query image. The SCR relocalizer system 170 can also apply a pose solver algorithm to estimate a pose of a camera (e.g., of a client device 110) that captured the query image based on the mappings of the pixels to the 3D coordinates. In other embodiments, the trained SCR models may be deployed to a different server (not pictured) (e.g., through an API or other communication protocols) that perform recolzation using query images received from client device. In yet other embodiments, the SCR relocalizer system 170 provides a trained model to a client device, where it is used for relocalization (e.g., by SCR relocalizer module 145). The SCR relocalizer module 145 may include functionality to load and initialize the SCR model on the client device 110 to perform inference and determine the pose of the client device from images captured by one or more cameras of the client device.

The network 105 can be any type of communications network, such as a local area network (e.g. intranet), wide area network (e.g. Internet), or some combination thereof. The network can also include a direct connection between a client device 110 and the game server 120. In general, communication between the game server 120 and a client device 110 can be carried via a network interface using any type of wired or wireless connection, using a variety of communication protocols (e.g. TCP/IP, HTTP, SMTP, FTP), encodings or formats (e.g. HTML, XML, JSON), or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

In addition, in situations in which the systems and methods discussed herein access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Example Methods

FIG. 4 is a conceptual diagram that depicts the training process of the SCR model (without guidance of priors from a second, scene agnostic model), in accordance with one or more embodiments. As described above, the SCR relocalizer system 170 may use a trained SCR model to perform scene coordinate prediction, and subsequently determine the camera pose of the client device to accurately generate virtual content.

Generally, a camera pose h can be estimated given a single RGB image I, based on the 3D scene coordinates generated by the SCR model and the corresponding 2D pixel positions of the input image. The camera pose is defined as a rigid body transformation that maps coordinates in a camera space eᵢ to coordinates in a scene space yᵢ, therefore yᵢ=heᵢ. The camera pose can be estimated from the image-to-scene correspondences:

$$h = g ( C ) , with C = \{ ( {x}_{i} , {y}_{i} ) \} \qquad ( 1 )$$

where C is the set of correspondences between 2D pixel positions xᵢ and 3D scene coordinates yᵢ, and function g represents a robust pose solver, which may be a PnP minimal solver in a RANSAC loop followed by refinement.

Scene coordinate regression may be used to obtain image-to-scene correspondences. A function ƒ (e.g., SCR model) to predict 3D scene points for any 2D image location is learned, represented by:

$${y}_{i} = f ( {p}_{i} ; w ) , with {p}_{i} = P ( {x}_{i} , I ) \qquad ( 2 )$$

where ƒ is parametrized by learnable weights w. The function ƒ receives an image patch pᵢ extracted around pixel position xᵢ from mapping image/and produces a 3D coordinate yᵢ. Thus, ƒ implements a mapping from patches to coordinates, ƒ: R^{C}^{₁}^{×H}^{_{P}}^{×W}^{_{P}}→R³.

In the example SCR model depicted in FIG. 4, the SCR model includes a convolutional backbone and a regression head. The convolutional backbone 430 may be implemented using a scene-agnostic convolutional network, and the regression head 465 may be implemented as a scene specific regression multi-layer perceptron (MLP) head. The overall model is represented by:

$$f ( {p}_{i} ; w ) = {f}_{H} ( {f}_{i} ; {w}_{H} ) , with {f}_{i} = {f}_{B} ( {p}_{i} ; {w}_{B} ) \qquad ( 3 )$$

where ƒ_{B} is the convolutional backbone 430 that predicts a high-dimensional feature ƒᵢ with dimensionality C_{F}, and ƒ_{H} is the MLP regression head 465 that predicts 3D scene coordinates yᵢ based on the feature ƒᵢ. This can be further represented by:

$${f}_{B} : {R}^{{C}_{I} \times {H}_{P} \times {W}_{P}} \to {R}^{{C}_{f}} {f}_{H} : {R}^{{C}_{f}} \to {R}^{3} \qquad ( 4 )$$

where ƒ_{B} outputs a feature tensor, and ƒ_{H} processes the feature tensor to generate the scene coordinates. RGB images or grayscale images with C_{I}=1 may be used as input. The training process of the SCR model is explained below.

In general, the SCR model is learned by optimizing over all mapping images I_{M} with the ground truth poses

$${h}_{i}^{*}$$

as supervision, represented below:

$${arg min}_{w} {\sum }_{I ∈ {I}_{M}} {\sum }_{i} {l}_{π} [ {x}_{i} , {\overbrace{f ( {p}_{i} ; w )}}^{{y}_{i}} , {h}_{i}^{*} ] \qquad ( 5 )$$

where l_{π} is a reprojection loss. Equation 5 is optimized using minibatch stochastic gradient descent, which updates the model parameters based on the gradient of loss with respect to a small subset of the training data. The neural network predicts dense scene coordinates from one mapping image at a time, with all predictions supervised using the ground truth mapping pose.

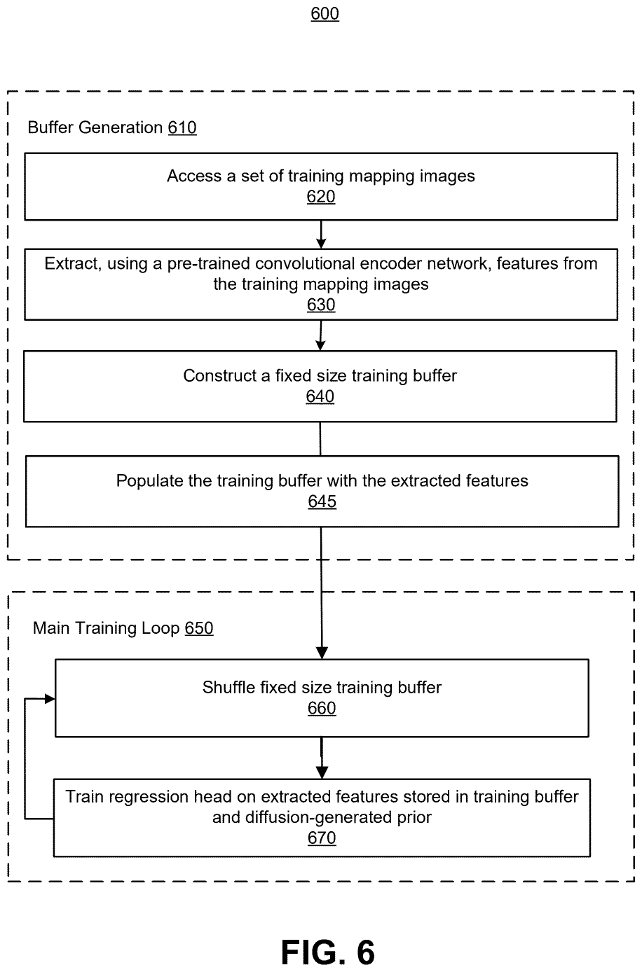

In an embodiment, the SCR relocalizer system 170 trains the SCR model in two stages, the first stage including pre-training the convolutional backbone, and the second stage including training the MLP regression heads on a new scene. For the first stage, the SCR relocalizer system 170 pre-trains the convolutional backbone 430 on input images from different environments, the convolutional backbone 430 trained on an N number of scenes in parallel. The convolutional backbone 430 may be trained using image-level training and curriculum training, with a pixel-wise reprojection loss function. This is described in further detail below in the description of FIG. 6.

For the second stage, the SCR relocalizer system 170 trains the one or more MLP regression heads 465 attached to the convolutional backbone, each MLP regression head on a new scene. The training process of the MLP regression heads 465 can be further divided into two stages, the buffer generation stage 420 and the main training loop 450. In the buffer generation stage 420, a fixed sized training buffer 435 is constructed. The SCR relocalizer system 170 constructs the training buffer 435 by passing the mapping images 425 through the convolutional backbone 430 that extracts high-dimensional feature vectors. Each feature 440 is represented by a box in the training buffer 435, and features from the same mapping image 445 are illustrated with a similar pattern fill. The training buffer 435 is generated once in the first minute of training.

The main training loop 450 outlines the training process for the scene specific MLP regression heads 465 on new scenes, the regression heads 465 configured to predict the scene coordinates based on features generated by the convolutional backbone. At the beginning of each epoch, the training buffer 435 is shuffled 455 to mix features 440 (e.g., patches) across all mapping data. At each training step, training batches 460 are constructed with several thousand random features and the associated mapping poses, and a parameter update over thousands of mapping views is computed at once. By randomizing the patches over the entire training set and constructing training batches from many different mapping views, the gradients are decorrelated within a batch and leads to a very stable training signal, robustness to high learning rates, and fast convergence. This also increases efficiency for gradient computation for the MLP regression head 465.

The MLP regression head 465 makes a scene coordinate prediction 470. A tanh-based pixel-wise reprojection loss function is used to calculate a reprojection loss 480, which measures the difference between the predicted scene coordinates and the ground truth scene coordinates 475. The reprojection loss is used to train the MLP regression head 465 to minimize error between the predicted scene coordinates and the ground truth scene coordinates.

In some embodiments, a scene agnostic model may be used to provide a prior to aid in the training of the regression head 465. The scene agnostic model may be trained on point clouds of scenes similar to ones in which the relocalizer will ultimately be applied (e.g., if the relocalizer is for use indoors, the point clouds may all be for other indoor scenes) or a wide range of scenes with different properties (e.g., a mix of indoor and outdoor scenes). Specifically, the scene agnostic model is trained to encode knowledge about plausible scene geometries. Thus, the scene agnostic model provides an estimate of how likely a point cloud generated by the regression head 465 is to be correct. This likelihood can then be used to guide further training of the regression head 465 towards generation of more likely point clouds.

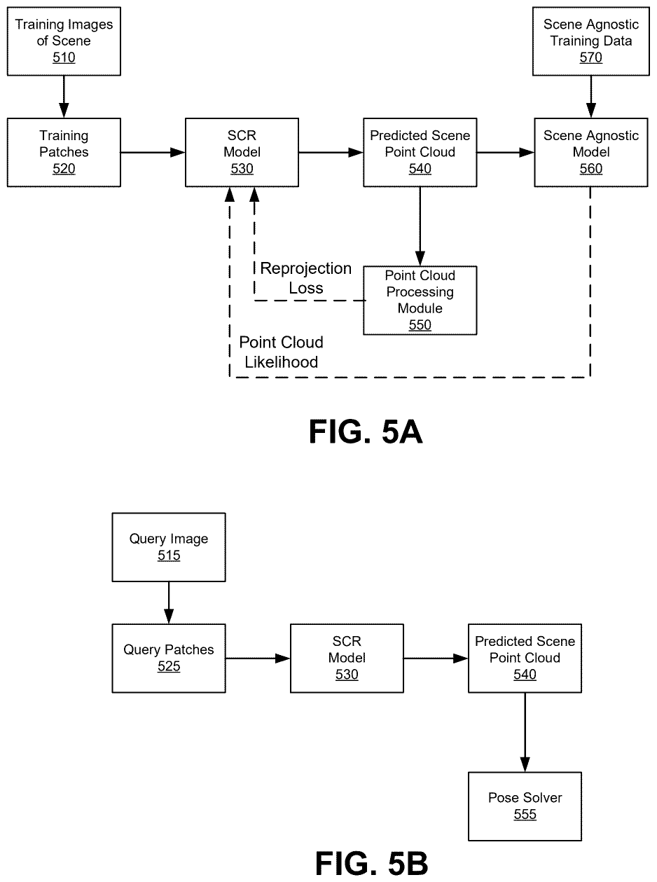

FIG. 5A illustrates how the scene agnostic model is incorporated into the process of training a SCR model for a specific scene, according to one embodiment. As described previously, a set of training patches 520 are extracted from a set of training images depicting portions of the scene. The training patches 520 are provided as input to the SCR model 530, which generates a predicted point cloud 540 of the scene. The predicted point cloud 540 is provided to a point cloud processing module 550 which projects the predicted point cloud 540 onto the original images using known ground truth poses. A reprojection loss can then be calculated between the projected points and the image positions from the training patches 520, which is fed back as a supervision signal to the SCR model 530

The predicted point cloud 540 is also provided to the scene agnostic model 560. The scene agnostic model 560 is trained on scene agnostic training data 570 to learn a prior of plausible geometries in the real world. The scene agnostic training data 570 includes images (or patches of images) of a range of scenes, not including the scene for which the SCR model is being trained. The trained scene agnostic model 560 outputs a likelihood metric indicating a likelihood that the predicted point cloud 540 accurately represents the scene (e.g., the gradient of the log-likelihood). The metric indicating the point cloud likelihood is also fed back to the SCR model 530 as a supervision signal. Thus, the SCR model 530 can be updated to better predict the ground truth training poses based on the reprojection loss while being directed towards producing point clouds that are probable accurate representations of real-world geometry based on the likelihood metric.

In one embodiment, the scene agnostic model 560 is a diffusion model. The regression head 465 may initially be trained without consideration of the diffusion model and once a threshold is passed (e.g., after 5000 training iterations), the diffusion model is applied for regularization in training of the regression head 465. Once the threshold is passed, a given timestep of the diffusion model may be applied in conjunction with the next training iteration and thereafter the timestep of the diffusion process to use may be interpolated (e.g., linearly interpolated) such that timestep zero of the diffusion process is applied during the last training iteration (e.g., iteration 25,000). The diffusion model may also be not applied for points with reprojection errors less than a threshold (e.g., 30 pixels) on the assumption that sufficient multi-view constraints exist for these points, so information gleaned from other scenes as provided by the diffusion model is not required.

FIG. 5B illustrates the application of the trained SCR model 530 at test/inference time to determine poses for previously unseen images of the scene. The trained SCR model 530 is provided with query patches 525 extracted from a query image 515 of the scene. The trained SCR model 530 generates a predicted scene point cloud 540 for the query image 515. The predicted scene point cloud 540 is provided to a pose solver 555, which replaces the point cloud processing module 550. The pose solver 555 applies a pose solver algorithm (e.g., a PnP minimal solver in a RANSAC loop, as described above) to generate a predicted pose for the query image 515. In the embodiment shown in FIG. 5B, the scene agnostic model 560 is not used at test/inference time, and thus the incorporation of the scene agnostic model 560 for training does not significantly impact efficiency of the SCR model 530 for inference.

### Example Methods

FIG. 6 is a flowchart that describes a method 600 for training a scene-specific regression head network without using guidance from priors generated by a model trained using scene agnostic training data (e.g., a point cloud diffusion model), in accordance with one embodiment. The method 600 yields a trained MLP regression head that combines with the convolutional backbone 430 to generates predicted scene coordinates for image pixels. The steps of FIG. 6 are illustrated from the perspective of the SCR relocalizer system 170 performing the method 600. However, some or all of the steps may be performed by other entities or components. In addition, some embodiments may perform the steps in parallel, perform the steps in different orders, or perform different steps.

Prior to method 600, as described in FIG. 4, the convolutional backbone 430 is pre-trained using a set of training mapping images. The convolutional backbone 430 may be any dense feature description network with descriptors that are distinctive for any position in the input image. In an embodiment, the backbone architecture consists of the first N number of layers (e.g., N=10, including skip connections) of the DSAC* network design.

The convolutional backbone 430 is trained on a set of training mapping images with N regression heads for N scenes, in parallel. For example, the convolutional backbone 430 may be trained on one hundred scenes in parallel and attaches one hundred regression heads to its end. The set of training mapping images may be acquired from users. The training images may be collected while users scan wayspots or other locations of interest while playing games, or from any relevant third-party entity (e.g., developers interested in using the relocalization service API). The set of training images contains images from multiple scenes. A portion of the set of training images may be heavily augmented, through various methods such as brightness and contrast jitter, saturation and hue jitter, image warping and random re-scaling of images. The backbone may be trained with half-precision floating point weights.

In an embodiment, the convolutional backbone 430 is trained using an image-level training approach, and is combined with curriculum training to mimic end-to-end training. Accordingly, the network can focus on good predictions and neglect less precise predictions that would be filtered by RANSAC during pose estimation. The training loss based on the pixel-wise reprojection loss is represented by:

$${l}_{π} [ {x}_{i} , {y}_{i} , {h}_{i}^{*} ] = \{ \begin{matrix}{\hat{e}}_{π} ( {x}_{i} , {y}_{i} , {h}_{i}^{*} ) & if {y}_{i} ∈ V \\ {‖ {y}_{i} - {\overline{y}}_{i} ‖}_{0} & Otherwise\end{matrix} . \qquad ( 6 )$$

where a robust reprojection error ê_{π} is optimized for all valid coordinate predictions V. Valid predictions are within a range (e.g., 10 cm and 1000 m) in front of the image plane, and have a reprojection error below a threshold (e.g., 1000 px). For invalid predictions, the reprojection loss optimizes the distance to a dummy scene coordinate y̅ᵢ that is calculated from the ground truth camera pose assuming a fixed image depth (e.g., 10 m). Accordingly, the pre-trained backbone is used to extract dense descriptors on any new scene, the extracted descriptors used to train the regression heads, described below by method 600.

As described in FIG. 4, the MLP regression heads 465 are trained during a second stage of training which is depicted by FIG. 6. In one embodiment, the MLP regression head 465 is composed of eight 1×1 convolutional layers, of width 512, with skip connections after layers three and six; followed by a final 1×1 convolutional layer that produces the scene coordinates. The regression head layers may use half-precision floating point weights. The MLP regression heads may be configured to directly regress the scene coordinates or regress homogenous coordinates. In the former case, the last layer would output a 3-channel tensor, while in the latter case, the last layer would output a 4D tensor (\dot{x}, \dot{y}, ż, ŵ), with \dot{y}=(\dot{x}, \dot{y}, ż)^{T} being the homogeneous representation of the 3D scene coordinates, and ŵ∈R being an unnormalized homogeneous parameter. w∈R⁺ is calculated from ŵ by applying a biased and clipped Softplus operator to ŵ, and the scene coordinates are subsequently de-homogenized. Specifically, w may be calculated as follows:

$$w = min ( \frac{1}{{S}_{min}} , {β}^{- 1} \cdot log ( 1 + exp ( β \cdot \hat{w} ) ) + \frac{1}{{S}_{max}} ) \qquad ( 7 )$$

where Sₘᵢₙ and Sₘₐₓ are used to clip the scale factor determined by w, and β is a parameter used to ensure that when the network outputs ŵ=0, the resulting homogeneous parameter w=1.

Accordingly, the network is steered towards producing a neutral homogeneous parameter, wherein it is centered on 1. In an embodiment,

$$β = \frac{log ( 2 )}{1 - {S}_{max}^{- 1}} .$$

The output of the network is de-homogenized into the tensor y containing 3D scene coordinates:

$$y = \frac{\dot{y}}{w} \qquad ( 8 )$$

For both the cases of direct regression the scene coordinates and regression of homogenous coordinates, the coordinates output by the network are learned relatively to the “mean” translation of the camera poses associated to the mapping frames for numerical stability.

The MLP regression head network may be trained in two stages: a buffer generation stage 610, and a main training loop 650. During the buffer generation stage 610, the SCR relocalizer system accesses 620 a set of training mapping images depicting new scenes to be mapped. The training images are augmented using a similar approach that is used in the convolutional backbone training. The training images may be augmented with different (e.g., weaker) data augmentation parameters, if the convolutional backbone was already trained on strongly augmented images.

The SCR relocalizer system 170 provides the training mapping images to the pre-trained convolutional backbone, which extracts 630 features from the training images. The SCR relocalizer system constructs 640 a fixed size training buffer. For example, the buffer may contain 8 million 512-channel patch descriptors, along with the associated 2D location in the source image, mapping camera pose, and intrinsic parameters. The SCR relocalizer system 170 populates 645 the training buffer with extracted high-dimensional feature vectors produced by the convolutional backbone. For each training mapping image processed by the convolutional backbone, an M number (e.g., M=1024) of patches and corresponding feature descriptors are randomly selected to be copied into the training buffer, along with other metadata (e.g., 2D patch location, camera pose and intrinsics). In another embodiment, feature selection is not random, and instead, the features may be assigned a score (or weight) computed by the SCR model. For example, the relocalizer model may assign different scores to different features in an image, allowing it to emphasize important information. Accordingly, the features selected to be copied into the training buffer may have a higher score assigned compared to other features. Thus, the regression heads are trained on more important regions of the image.

During the main training loop 650, at the beginning of each epoch, the training buffer is shuffled 660 to mix features (or patches) across all mapping data. The regression head is trained 670 on extracted features stored in the training buffer. As described above, the regression head is trained by repeatedly iterating over the shuffled training buffer. Shuffling the training buffer randomizes patches over the entire training set, and constructs training batches from many different mapping views. Accordingly, reducing correlation between gradients within a batch, and leading to a stable training signal, robustness to high learning rates, and, ultimately, fast convergence. In one embodiment, the training in the main training loop 650 uses the output of the diffusion model as a supervisory signal, as described previously.

The MLP regression heads 465 may be trained using a tanh-based loss function on reprojection errors. The function may be dynamically rescaled according to a circular schedule with a threshold decreasing throughout the length of the training process. This is represented below:

$${\hat{e}}_{π} ( {x}_{i} , {y}_{i} , {h}_{i}^{*} ) = τ ( t ) tanh ( \frac{{e}_{π} ( {x}_{i} , {y}_{i} , {h}_{i}^{*} )}{τ ( t )} ) \qquad ( 9 )$$

where τ represents a threshold of reprojection error e_{π}. The tanh function is dynamically rescaled according to the threshold τ that varies throughout training, represented below:

$$τ ( t ) = w ( t ) {τ}_{max} + {τ}_{min} , with w ( t ) = \sqrt{1 - {t}^{2}} \qquad ( 10 )$$

where t∈(0, 1) denotes the relative training progress. This curriculum implements a circular schedule of threshold τ, which remains close to τₘₐₓ at the beginning of training, and declines towards τₘᵢₙ at the end of training.

Additionally, the entire network may be trained with half-precision floating point weights, which results in an additional speed boost. The neural networks may also be stored with float16 precision, which allows an increase in the depth of our regression heads while maintaining small (e.g., 4 MB) maps. In conjunction with the curriculum training, a one cycle learning rate schedule can be used (e.g., increasing the learning rate in the middle of training and reducing it towards the end). An advantage was observed in overparameterizing the scene coordinate representation by predicting the homogeneous coordinates y′=(x, y, z, w)^{T} and applying a w-clip, enforcing w to be positive by applying a Softplus operation.

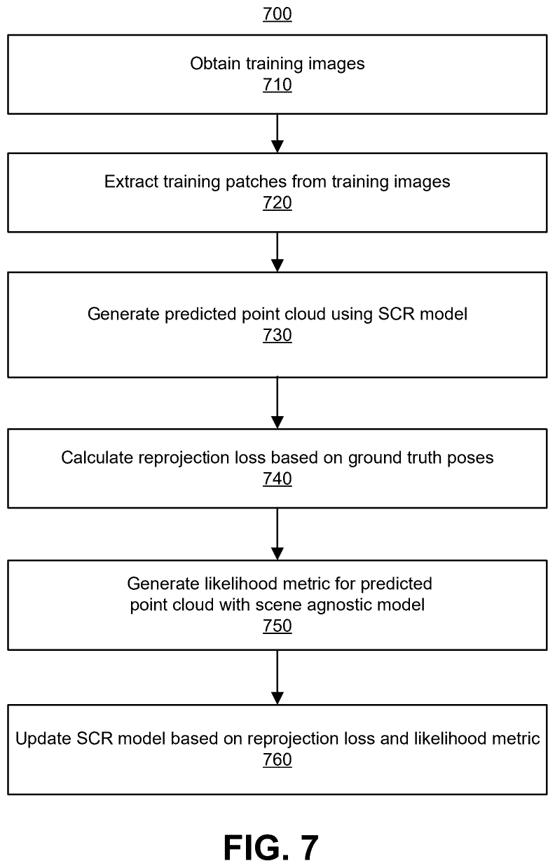

FIG. 7 is a flowchart of a method 700 for training the SCR model that incorporates priors generated using a scene agnostic model, according to one embodiment. FIG. 7 illustrates one iteration of the training process, but it should be appreciated that the training process will in practice iterate for many (e.g., thousands of) cycles. The steps of FIG. 7 are illustrated from the perspective of the SCR relocalizer system 170 performing the method 700. However, some or all of the steps may be performed by other entities or components. In addition, some embodiments may perform the steps in parallel, perform the steps in different orders, or perform different steps.

In the embodiment shown, the method 700 begins with the SCR relocalizer system 170 obtaining 710 training images. The training images depict the scene for which the SCR model is being trained. In one embodiment, the SCR relocalizer system 170 extracts 720 training patches from the training images. In later iterations, some or all of the same training images or training patches may be reused. Additionally or alternatively, some iterations may obtain 710 new training images or extract 720 new training patches from the training images.

The SCR relocalizer system 170 generates 730 a predicted point cloud by applying the SCR model to the training patches. SCR models encode a scene into a scene-specific neural network ƒ. The network ƒ maps an image patch pᵢ centered around pixel i of image I to a 3D scene point yᵢ: yᵢ=ƒ(pᵢ; W), where w denotes the learnable parameters of ƒ that implicitly encode the scene.

During training, the SCR relocalizer system 170 may calculate 740 a reprojection loss, Lᵣₑₚᵣₒⱼ, from the differences between the predicted scene coordinates and one or more ground truth poses. The ground truth poses are known poses for ground truth images. The ground truth images can be the same or different images from the training images. With multiple ground truth images I_{M} and their known camera poses for a specific scene, ƒ can be optimized using the reprojection loss Lᵣₑₚᵣₒⱼ. However, when multi-view constraints from the images are insufficient or ambiguous, ƒ may (partly) degenerate, and estimate scene points yᵢ that are noisy, distorted, or plain outliers. Such artifacts in the scene coordinate prediction may lead to degraded performance in downstream tasks, such as relocalization.

To mitigate this, the SCR relocalizer system 170 generates 750 a likelihood metric for the predicted point cloud generated 730 by the SCR mode. The relocalizer system 170 generates 750 the likelihood metric using a scene agnostic model that predicts the gradient of the log-likelihood of the predicted point cloud. The scene agnostic model is trained on an external corpus of scenes to learn a prior of plausible scene geometries.

In one embodiment, the scene agnostic model is a point cloud diffusion model. The posterior probability for the scene points y, given the mapping images I_{M} and poses h*, is proportional to the product of the likelihood p(h*, I_{M}|y) and the prior p(y):

$$p ( y \vert {h}^{*} , {I}_{M} ) = \frac{p ( {h}^{*} , {I}_{M} \vert y ) p ( y )}{p ( {h}^{*} , {I}_{M} )} \qquad ( 11 )$$

Taking the negative logarithm of the posterior and differentiating it with respect to y yields:

$$- ∇ log p ( y \vert {h}^{*} , {I}_{M} ) = - ∇ log p ( {h}^{*} , {I}_{M} \vert y ) - ∇ log p ( y ) \qquad ( 12 )$$

where the constant p(h*, I_{M}) can be omitted after differentiation.

Training the SCR model by minimizing Lᵣₑₚᵣₒⱼ can be interpreted as maximizing the log-likelihood of the mapping views and poses given the predicted scene points, assuming a certain error distribution. The relationship can be expressed as:

$${L}_{reproj} = - log ( p ( {h}^{*} , {I}_{M} \vert y ) ) \qquad ( 13 )$$

Substituting equation 13 into equation 12 enables expression of the gradient of the posterior loss as:

$$∇ L = ∇ {L}_{reproj} - ∇ log p ( y ) \qquad ( 14 )$$

In which the first term corresponds to the likelihood term introduced in equation 5 and the second term represents the prior for 3D scene points, y.

As explained previously, the prior can be generated by a point cloud diffusion model. In a general forward diffusion process, Gaussian noise ϵ is progressively added to an input signal x₀ over T timesteps until the signal becomes completely noisy. Diffusion models learn to recover the original signal x₀ by estimating the noise added to the noisy signal x_{τ} at a certain timestep τ∈[0, T−1], through a neural network ϵ_{θ}.

The noise estimation is proportional to the score function of the input signal, i.e.:

$${ϵ}_{θ} ( {x}_{τ} , τ ) ∝ - {∇}_{x} log {p}_{x} \qquad ( 15 )$$

This enables approximation of the prior term in equation 14 with a diffusion denoising model ϵ_{θ} for the 3D points, y. By substituting equation 15 into equation 14, the overall loss gradient at the mapping stage can rewritten as:

$$∇ L = ∇ L\_reproj + {λ}_{r e g} {ϵ}_{θ} ( y , τ ) \qquad ( 16 )$$

where λ_{reg} is a weight balancing out the prior and the reprojection loss.

In one embodiment, the diffusion model noise estimator ϵ_{θ}(y, τ) takes the noisy point cloud generated by the SCR model (x_{τ}∈ [symbol] ^{N×3}) and the diffusion timestep (τ) as inputs to predict the noise associated with each point. The input point cloud may be encoded for input using any suitable embedding or encoding technique. The point cloud diffusion model may be trained iteratively. In each forward iteration, the input point cloud (x₀) is normalized with a predefined scaling factor to ensure the points are in a desired range (e.g., [−1,1]). The input point cloud (x₀) is then transformed to a noisy version (x_{τ}) by adding noise according to a noise schedule at a randomly sampled time step τ. In one embodiment, the training objective of the point cloud diffusion model may be expressed as:

$${L}_{training} = {𝔼}_{τ , ϵ ∼ 𝒩 ( 0 , 1 ) , {x}_{0}} [ {‖ ( ϵ - {ϵ}_{θ} ( {x}_{τ} , τ ) ) ‖}_{2}^{2} ] \qquad ( 17 )$$

Once the diffusion mode is trained, it can be integrated into the SCR model mapping process. In one embodiment, the SCR relocalizer system 170 takes the estimated scene points y as input for the trained diffusion model and estimates the noise. The estimated noise can be used for regularization as specified in equation 16. In other words, the SCR relocalizer system 170 can generate 750 a likelihood metric from the diffusion model, with the likelihood metric corresponding to the estimated amount of noise, where larger amounts of noise indicating a less plausible geometry.

Having calculated 740 the reprojection loss and generated 750 the likelihood metric, the SCR relocalizer system 170 updates 760 the SCR model based on the reprojection loss and the likelihood metric. As explained previously, minimizing the reprojection loss causes the SCR model to be configured in a way that accurately predicts the training poses while minimizing the likelihood metric directs the SCR model training to solutions that also provide plausible real-world geometries. Since the prediction yᵢ generated by the trained SCR model represents a 2D-3D correspondence from pixel i to scene space, the outputs of the SCR model can be used for camera pose estimation by feeding them into a pose solver algorithm (e.g., RANSAC and PnP). Note that although the reprojection loss and likelihood metric are described as being minimized, it should be appreciated that these values could be formulated such that high values indicate a well-trained model that generates plausible geometries, and that with such formulations the values should be maximized in training.

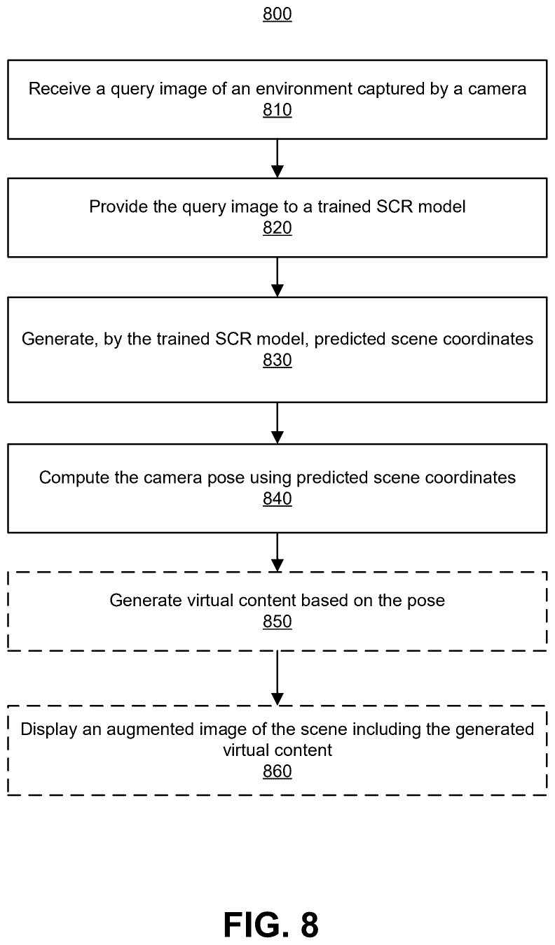

FIG. 8 is a flowchart that describes the generation of camera poses to provide virtual content, according to one embodiment. The method 800 results in an estimated pose for the camera that captured an input query image which may be used to provide virtual content. The steps of FIG. 8 are illustrated from the perspective of a server (e.g., game server 120) and a client device (e.g., client device 110) coordinating to perform the method 800. However, some or all of the steps may be performed by other entities or components. In addition, some embodiments may perform the steps in parallel, perform the steps in different orders, or perform different steps.

The server receives 810 an input query image of an environment captured by a camera of the client device. The input query image may have attached metadata indicating additional information about the input query image, such as camera intrinsics, a time stamp, an estimated location (e.g., GPS coordinates), and the like. The client device provides 820 the input query image to a trained SCR model. As described above, the SCR model may be trained using priors generated by a diffusion model to guide the training towards plausible scene geometries. In some embodiments, the client device may also provide some or all of the metadata associated with the image to the trained SCR model. The trained SCR model generates 830 predicted scene coordinates for the image pixels, producing the correspondence between the 3D scene coordinates and the 2D pixel positions.

The server computes 840 the camera pose using the predicted scene coordinates generated by the SCR model. As described previously with reference to FIG. 4, a camera pose h is calculated using a robust pose solver g that uses the correspondence between the 3D scene coordinates and the pixels of the image. The pose solver may include a PnP minimal solver in a RANSAC loop, or other suitable algorithms, and may be followed by refinement. Refinement includes iterative optimization of the reprojection error over all RANSAC inliers using an optimization algorithm, such as Levenberg-Marquardt.

The server returns the resulting camera pose to the client device over the network. In one embodiment, the client device uses the camera pose to generate 850 virtual content. The client device may display 860 an image or a video feed of the scene augmented with the virtual content. For example, a physical object may be augmented with virtual content that interacts with the physical object. Alternatively, the virtual content may be presented on transparent or semi-transparent display (e.g., of an AR headset) such that it appears overlaid on a user's view of the real world.

### Example Computing System

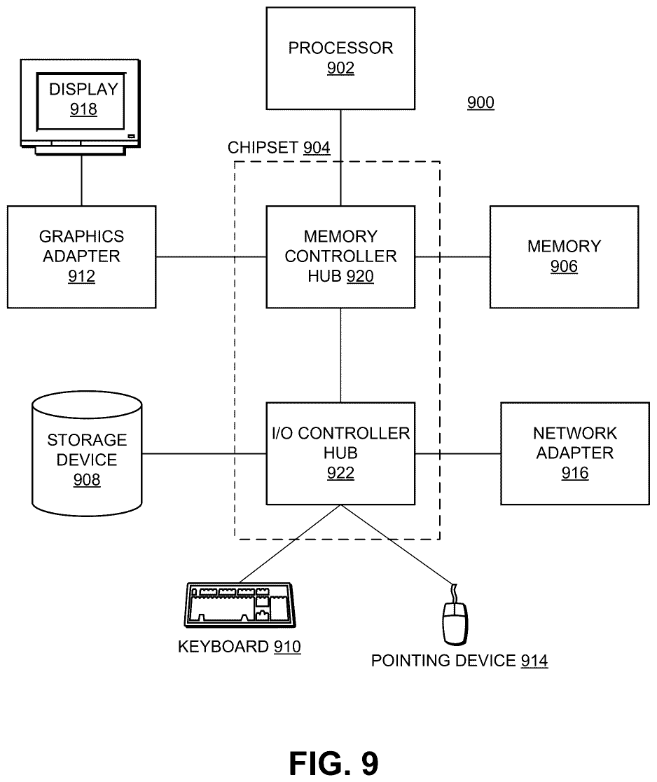

FIG. 9 is an example architecture of a computing device, according to an embodiment. Although FIG. 9 depicts a high-level block diagram illustrating physical components of a computer used as part or all of one or more entities described herein, in accordance with an embodiment, a computer may have additional, less, or variations of the components provided in FIG. 9. In practice, and as recognized by those of ordinary skill in the art, items shown separately could be combined and some items could be separated.

Illustrated in FIG. 9 are at least one processor 902 coupled to a chipset 904. Any functionality attributed to “a processor” may be performed by one or more processors, operating individually or in conjunction with each other. Also coupled to the chipset 904 are a memory 906, a storage device 908, a keyboard 910, a graphics adapter 912, a pointing device 914, and a network adapter 916. A display 918 is coupled to the graphics adapter 912. In one embodiment, the functionality of the chipset 904 is provided by a memory controller hub 920 and an I/O hub 922. In another embodiment, the memory 906 is coupled directly to the processor 902 instead of the chipset 904. In some embodiments, the computer 900 includes one or more communication buses for interconnecting these components. The one or more communication buses optionally include circuitry (sometimes called a chipset) that interconnects and controls communications between system components.

The storage device 908 is any non-transitory computer-readable storage medium, such as a hard drive, compact disk read-only memory (CD-ROM), DVD, or a solid-state memory device or other optical storage, magnetic cassettes, magnetic tape, magnetic disk storage or other magnetic storage devices, magnetic disk storage devices, optical disk storage devices, flash memory devices, or other non-volatile solid state storage devices. Such a storage device 908 can also be referred to as persistent memory. The pointing device 914 may be a mouse, track ball, touchscreen, or other type of pointing device, and is used in combination with the keyboard 910 to input data into the computer 900. The graphics adapter 912 displays images and other information on the display 918. The network adapter 916 couples the computer 900 to a local or wide area network, such as network 105.

The memory 906 holds instructions and data used by the processor 902. The memory 906 can be non-persistent memory, examples of which include high-speed random-access memory, such as DRAM, SRAM, DDR RAM, ROM, EEPROM, flash memory.

As is known in the art, a computer 900 can have different or other components than those shown in FIG. 9. In addition, the computer 900 can lack certain illustrated components. In one embodiment, a computer 900 acting as a server may lack a keyboard 910, pointing device 914, graphics adapter 912, or display 918. Moreover, the storage device 908 can be local or remote from the computer 900 (such as embodied within a storage area network (SAN)).

As is known in the art, the computer 900 is adapted to execute computer program modules for providing functionality described. The term “module” refers to computer program logic utilized to provide the specified functionality. Thus, a module can be implemented in hardware, firmware, or software. In one embodiment, program modules are stored on the storage device 908, loaded into the memory 906, and executed by the processor 902.

### Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Where values are described as “approximate” or “substantially” (or their derivatives), such values should be construed as accurate +/−10% unless another meaning is apparent from the context. For example, “approximately ten” should be understood to mean “in a range from nine to eleven.”

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for verifying an account with an on-line service provider corresponds to a genuine business. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

1. A method, comprising:
receiving a query image of a scene;
applying a scene coordinate regression (SCR) model to the query image of the scene to generate predicted scene coordinates corresponding to pixels in the query image, wherein the SCR model was iteratively trained by a process comprising, for each iteration:
generating, based on a set of training images of the environment, predicted scene coordinates using the SCR model;
calculating a reprojection loss based on the predicted scene coordinates and known poses;
generating, using a scene agnostic model, a likelihood metric that the predicted scene coordinates are an accurate representation of the environment; and
updating the SCR model based on the reprojection loss and the likelihood metric,
wherein for at least some iterations of the training, a supervisory signal is used that was generated by a scene agnostic model that was trained on images of other environments, the supervisory signal indicating a likelihood that the scene coordinates are correct in view of information encoded by the scene agnostic model; and
applying a pose solver algorithm to the predicted scene coordinates to generate a camera pose.

2. The method of claim 1, wherein applying the SCR model to the query image comprises:
extracting patches from the query image; and
providing the patches as input to the SCR model.

3. The method of claim 2, wherein:
the patches are groups of connected pixels from the query image centered around corresponding primary pixels; and
the predicted scene coordinates are 2D-3D mappings for the primary pixels.

4. The method of claim 1, wherein the predicted scene coordinates are a predicted scene point cloud.

5. The method of claim 1, wherein the scene agnostic model is a diffusion model.

6. The method of claim 5, wherein the likelihood metric is a log-likelihood gradient for the predicted scene coordinates.

7. The method of claim 5, wherein the supervisory signal that was generated by the scene agnostic model is not applied in iterations before an iteration threshold and is applied to at least some iterations after the iteration threshold.

8. The method of claim 7, wherein the supervisory signal applied in an iteration corresponding to the iteration threshold is generated by a first timestep of the diffusion model and thereafter timesteps of the diffusion model used are interpolated such that timestep zero of the diffusion model is applied during a last training iteration.

9. The method of claim 5, wherein, the diffusion model is not applied for predicted scene coordinates with reprojection errors less than a threshold.

10. The method of claim 1, further comprising:
generating virtual content based on the camera pose; and
causing display of the virtual content in conjunction with a view of the scene.

11. A non-transitory computer-readable medium comprising stored instructions that, when executed by one or more processors, cause a computing system to perform operations including:
receiving a query image of a scene;
applying a scene coordinate regression (SCR) model to the query image of the scene to generate predicted scene coordinates corresponding to pixels in the query image, wherein the SCR model was iteratively trained by a process comprising, for each iteration:
generating, based on a set of training images of the environment, predicted scene coordinates using the SCR model;
calculating a reprojection loss based on the predicted scene coordinates and known poses;
generating, using a scene agnostic model, a likelihood metric that the predicted scene coordinates are an accurate representation of the environment; and
updating the SCR model based on the reprojection loss and the likelihood metric,
wherein for at least some iterations of the training, a supervisory signal is used that was generated by a scene agnostic model that was trained on images of other environments, the supervisory signal indicating a likelihood that the scene coordinates are correct in view of information encoded by the scene agnostic model; and
applying a pose solver algorithm to the predicted scene coordinates to generate a camera pose.

12. The non-transitory computer-readable medium of claim 11, wherein applying the SCR model to the query image comprises:
extracting patches from the query image; and
providing the patches as input to the SCR model.

13. The non-transitory computer-readable medium of claim 12, wherein:
the patches are groups of connected pixels from the query image centered around corresponding primary pixels; and
the predicted scene coordinates are 2D-3D mappings for the primary pixels.

14. The non-transitory computer-readable medium of claim 11, wherein the predicted scene coordinates are a predicted scene point cloud.

15. The non-transitory computer-readable medium of claim 11, wherein the scene agnostic model is a diffusion model.

16. The non-transitory computer-readable medium of claim 15, wherein the likelihood metric is a log-likelihood gradient for the predicted scene coordinates.

17. The non-transitory computer-readable medium of claim 15, wherein the supervisory signal that was generated by the scene agnostic model is not applied in iterations before an iteration threshold and is applied to at least some iterations after the iteration threshold.

18. The non-transitory computer-readable medium of claim 17, wherein the supervisory signal applied in an iteration corresponding to the iteration threshold is generated by a first timestep of the diffusion model and thereafter timesteps of the diffusion model used are interpolated such that timestep zero of the diffusion model is applied during a last training iteration.

19. The non-transitory computer-readable medium of claim 15, wherein, the diffusion model is not applied for predicted scene coordinates with reprojection errors less than a threshold.

20. The non-transitory computer-readable medium of claim 11, wherein the operations further include:
generating virtual content based on the camera pose; and
causing display of the virtual content in conjunction with a view of the scene.
